(19) United States
(12) Patent Application Publication
(10) Pub. No.: US 2006/0284385 A1
(43) Pub. Date: Dec. 21, 2006

(54) Barrel for a cutting tool

(76) Inventor: Chin-Chiu Chen, Taichung Hsien (TW)

Correspondence Address: Rabin & Berdo, P.C., Suite 500, 1101 14th Street, Washington, DC, 20005, US

(21) Appl. No.: 11/445,238

(22) Filed: Jun. 2, 2006

(30) Foreign Application Priority Data
Jun. 20, 2005 (TW) 094210333

(51) Int. Cl. B23B 31/00

(52) U.S. Cl. 279/20

(57) ABSTRACT

A barrel for a cutting tool has a body. The body has an outer end, an inner end, a groove radially defined in an outside wall of the body adjacent to the outer end of the body, a central hole axially defined in a center of the body. Multiple even-spaced first slots are respectively and axially defined in the outside wall of the body from the outer end to the inner end and are shorter than the body. Multiple even-spaced second slots respectively and axially defined in the outside wall of the body from the inner end to the outer end and are shorter than the body. Because the first slots do not communicate with the second slots, the water can concentrate in a passage of a cutting tool to achieve a good cooling efficiency.

### BACKGROUND OF THE INVENTION

1. Field of the Invention

The present invention relates to a barrel, and more particular to a barrel for a cutting tool which can cool the cutting tool efficiently.

2. Description of the Related Art

With reference to FIGS. 6 and 7, a conventional barrel for a cutting tool has a body (40). The body (40) is a barrel and has an outer end (41) and an inner end (42). The body (40) is tapered from the outer end (41) to the inner end (42). A groove (43) is defined radially around an outside wall of the body (40) near to the outer end (41).

A central hole (44) is defined axially in a center of the body (40), communicates the outer end (41) to the inner end (42) and has a first end formed in the outer end (41) of the body (40) and a second end formed in the inner end (42) of the body (40). Multiple even-spaced slots (45) are respectively and longitudinally defined in the outside wall of the body (40) and extends from the inner end (42) to the outer end (41) of the body (40). The even-spaced slots (45) alternatively communicates with the first and second ends of the central hole (44).

In usage, the inner end (42) of the body (40) is inserted into a cavity (51) in a tool shank (50) and a nut (52) is engaged with the groove (43) and a free end of the tool shank (50). Hence, the body (40) is tightly held inside the cavity (51) with the nut (52). Meanwhile, a cutting tool (60) with a passage (61) is inserted into and securely clamped in the central hole (44). With the arrangement of the slots (45), the body (40) can have a maximally extensional distortion to achieve a good clamping effect.

However, water that needs to be concentrated in the passage (61) to cool the cutting tool (60) easily flows into the slots (45) and is discharged from the slots (45) directly, such that some of the water is not applied to cool the cutting tool (60) and the cooling efficiency is lowered.

Therefore, the invention provides barrel for a cutting tool to mitigate or obviate the aforementioned problems.

### SUMMARY OF THE INVENTION

The main objective of the present invention is to provide a barrel for a cutting tool that can cool the cutting tool with a high efficiency.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a barrel for a cutting tool in accordance with the present invention;

FIG. 2 is a side view in partial section of the barrel for a cutting tool in FIG. 1;

FIG. 3 is a rear view of the barrel for a cutting tool in FIG. 1;

FIG. 4 is a front view of the barrel for a cutting tool in FIG. 1;

FIG. 5 is an operational cross-sectional side view of the barrel for a cutting tool in FIG. 1;

FIG. 6 is a perspective view of a conventional barrel for a cutting tool in accordance with the prior art; and

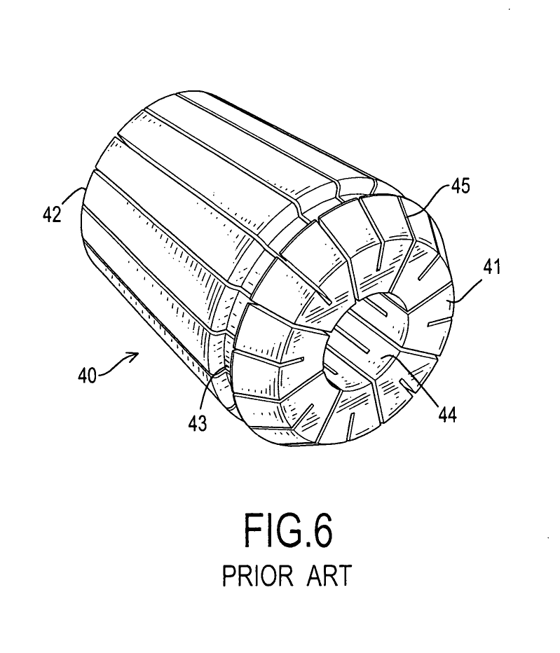

FIG. 7 is an operational cross-sectional side view of the conventional barrel for a cutting tool in FIG. 6.

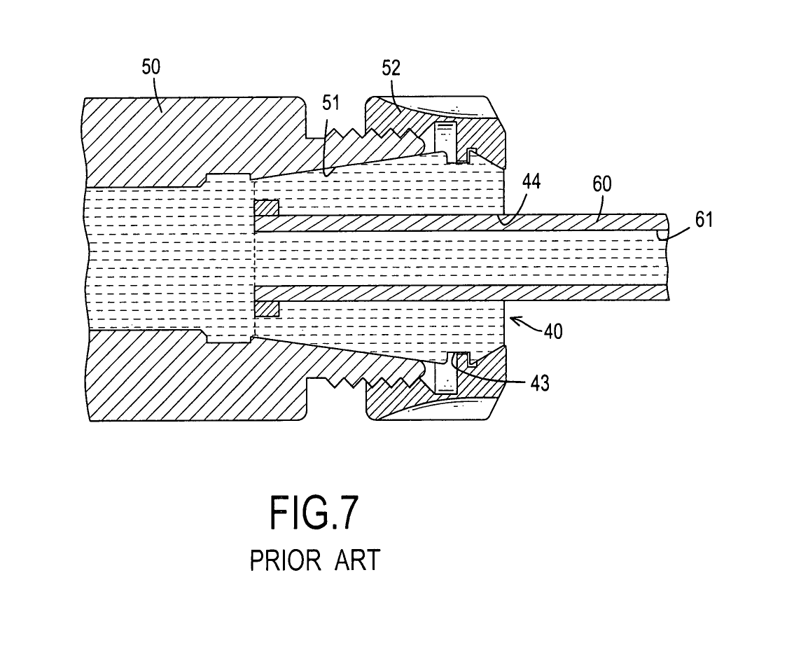

### DETAILED DESCRIPTION OF THE PREFERRED EMBODIMENT

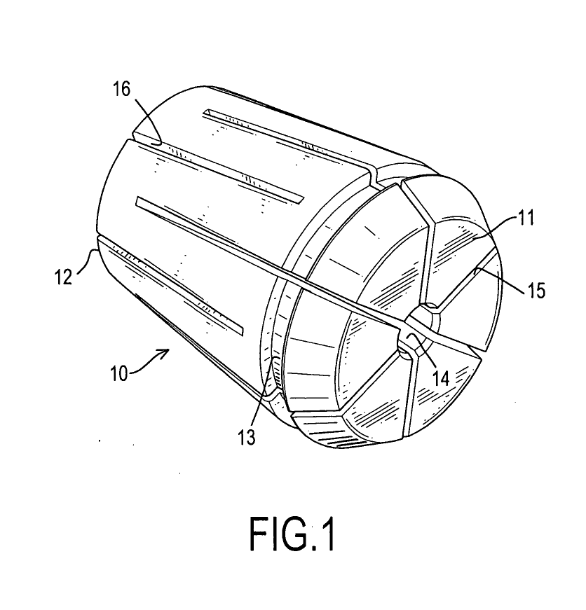

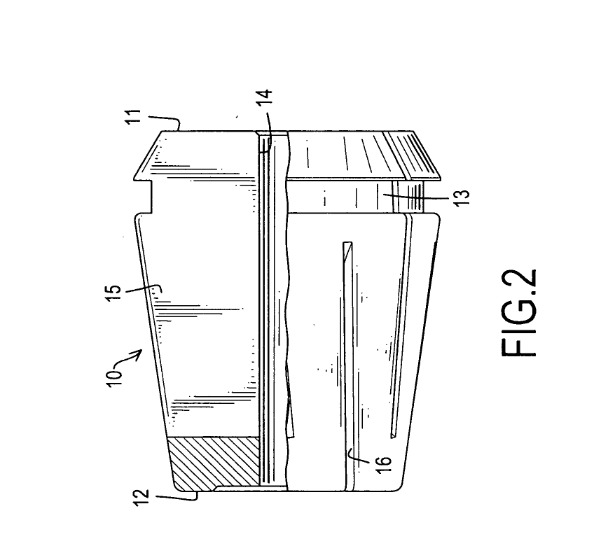

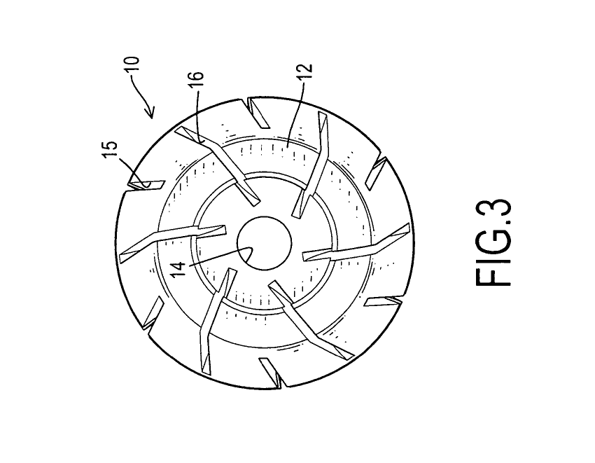

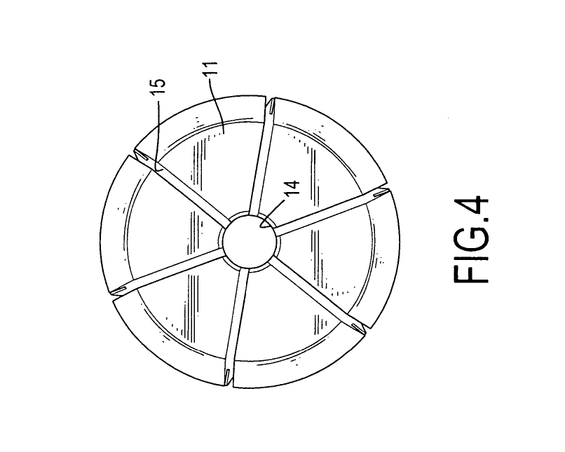

With reference to FIGS. 1-4, a barrel for a cutting tool (10) in accordance with the present invention has a body (10). The body (10) is a sleeve and has an outer end (11) and an inner end (12). The body (10) is tapered from the outer end (11) to the inner end (12). A groove (13) is radially defined around an outside wall of the body (10) near to the outer end (11).

A central hole (14) is defined axially in a center of the body (10), communicates the outer end (11) to the inner end (12) and has a first end formed in the outer end (11) of the body (10) and a second end formed in the inner end (12) of the body (10). Multiple even-spaced first slots (15) are respectively and longitudinally defined in the outside wall of the body (10) from the outer end (11) to the inner end (12). Each even-spaced first slot (15) is communicated with the first end of the central hole (14), is shorter than the body (10) and is spaced from the inner end of the body (10).

Multiple even-spaced second slots (16) are respectively and longitudinally defined in the outside wall of the body (10) from the inner end (12) to the outer end (11). Each even-spaced second slot (16) is communicated with the second end of the central hole (14), is shorter than the body (10) and is spaced from the outer end of the body (10).

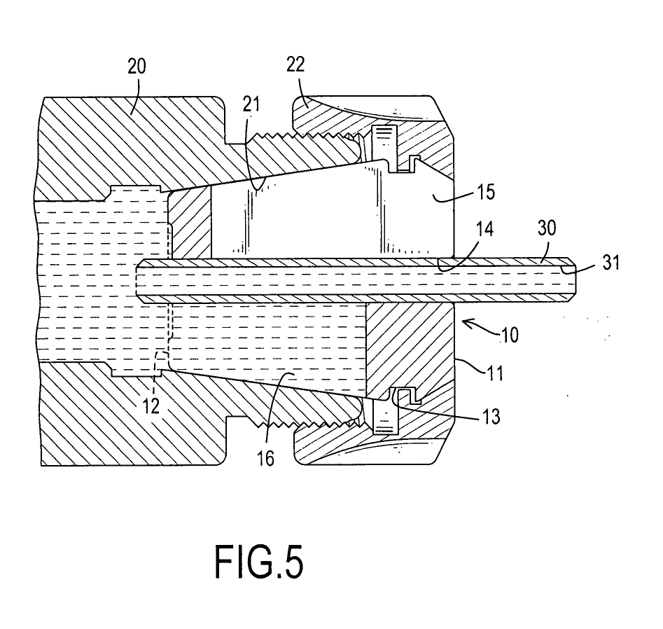

With reference to FIGS. 1 and 5, the inner end (12) of the body (10) is inserted into a cavity (21) of a tool shank (20) and a nut (22) is engaged with the groove (13) and a free end of the tool shank (10). Hence, the body (10) is tightly held inside the cavity (21) with the nut (22). Meanwhile, a cutting tool (30) with a passage (31) is inserted into and clamped in the central hole (14). With the arrangements of the first and the second slots (15, 16), the body (10) can have a maximally extensional distortion to achieve a good clamping effect.

In use, even when the water flows into the second slots (16), the water will flow back to the central hole (14) because the second slots (16) does not communicate with the first end of the central hole (14). In addition, only tiny water will flow into the first slots (15), but the water entering into the first slots (15) can still provide a cooling effect to the cutting tool (30) along the outer surface to the cutting tool (30). Accordingly, an excellent cooling efficiency is provided with the barrel in accordance with the present invention.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A barrel for a cutting tool comprising:
a body being a barrel and having
an outer end,
an inner end,
a groove radially defined around a outside wall of the body adjacent to the outer surface,
a central hole defined axially in a center of the body,
multiple even-spaced first slots respectively and axially defined in the outside wall of the body from the outer end to the inner end, being shorter than the body and spaced from the inner end of the body, and
multiple even-spaced second slots respectively and axially defined in the outside wall of the body from the inner end to the outer end, being shorter than the body and spaced from the outer end of the body.

2. The barrel for a cutting tool as claimed in claim 1, wherein
the central hole in the body has a first end formed in the outer end of the body and a second end formed in the inner end of the body;
each even-spaced first slot is communicated with the first end of the central hole; and
each even-spaced second slot is communicated with the second end of the central hole.
